(19) United States
(12) Patent Application Publication
(10) Pub. No.: US 2022/0078602 A1
(43) Pub. Date: Mar. 10, 2022

(54) SYSTEM AND METHOD FOR DATA TRANSFER

(71) Applicant: Arm Cloud Services Limited, Glasgow (GB)

(72) Inventors: Alan Christopher TAIT, Cambridge (GB); Niall Graham STRACHAN, Cambridge (GB)

(21) Appl. No.: 17/309,819

(22) PCT Filed: Dec. 16, 2019
(86) PCT No.: PCT/GB2019/053565

§ 371 Date: Jun. 21, 2021

(30) Foreign Application Priority Data
Dec. 21, 2018 (GB) 1821037.7

(51) Int. Cl. H04W 8/20; H04W 4/029; G06F 8/65

(52) U.S. Cl. CPC H04W 8/205; H04W 88/06; G06F 8/65; H04W 4/029

(57) ABSTRACT

A method of carrying out a data transfer comprising: providing a device having an Embedded Universal Integrated Circuit Card ‘e UICC’ enabled SIM with a first profile; providing a second profile, different from the first profile; installing the second profile on the SIM; using the second profile to carry out a data transfer; providing a third profile, different from the second profile; and installing the third profile on the SIM.

The present application relates to a system and method for data transfer, and in particular for data transfer for remote updating of devices.

### BACKGROUND

There is an increasing interest in wireless connected devices with wireless data connections, for example, for use as communication channels for the automatic reporting of data by the devices and sending of data and instructions to the devices. Such wireless connected devices and their connectivity are commonly referred to as the Internet of Things (loT), and may also be referred to as machine to machine (M2M) communication. In operation of the M2M or IoT devices it may be desirable to carry out updates of the software and/or firmware on the IoT devices.

Currently, such software or firmware updates to an IoT device are generally performed over the wireless data connection/communication channel which is used by the IoT device in normal operation for the automatic reporting of data. However, there are problems with this approach. Generally, the agreement with the connectivity supplier supporting the communication channel will be based upon the level and type of usage expected by the IoT device in normal operation to carry out the automatic reporting of data, such as the expected typical daily/monthly use. The amount of data to be transferred to carry out an update will usually be relatively large compared to the amount of data transferred in normal operation of the IoT device, so that the data transfer requirements of the update may be outside the terms of the agreement with the connectivity supplier, potentially leading to failure of carry out the update, or to the levying of out of bundle or outside agreement charges, which may make the update relatively costly. A further problem is that conventionally, software or firmware updates are generally initiated by sending an update notification SMS to the IoT device, which SMS instructs the device to download the update from a specific location, such as a secure server that contains the specific firmware files for the update. However, it is common for IoT devices to be without a wireless data connection, or in other words to be offline, for prolonged periods, so that reception of this update notification SMS may be delayed due to varying network conditions. In some cases this can result in the update notification SMS not being received as a message expiry time is set and triggered before the destination IoT device establishes a wireless data connection and comes online. The outcome of this scenario is that the IoT device never receives the update notification SMS and the update is not carried out. This can result in uncertainty whether or not an IoT device has been updated and may leave the device in a compromised or insecure state.

The embodiments described below are not limited to implementations which solve any or all of the disadvantages of the approaches described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the present disclosure provides a computer-implemented method of carrying out a data transfer comprising: providing a device having a Subscriber Identity Module ‘SIM’ supporting remote profile provisioning, and having a first profile; providing a second profile, different from the first profile; installing the second profile on the SIM; using the second profile to carry out a data transfer; providing a third profile, different from the second profile; and installing the third profile on the SIM.

In a second aspect, the present disclosure provides a computer-implemented method of carrying out a data transfer comprising: sending, to a device having a Subscriber Identity Module ‘SIM’ supporting remote profile provisioning, and having a first profile, a second profile to be installed on the SIM, the second profile being different from the first profile; carrying out a data transfer with the device using the second profile; sending to the device a third profile to be installed on the SIM, the third profile being different from the second profile.

In a third aspect, the present disclosure provides a data transfer system comprising: means arranged to send, to a device having a Subscriber Identity Module ‘SIM’ supporting remote profile provisioning, and having a first profile, a second profile to be installed on the SIM, the second profile being different from the first profile; means arranged to carry out a data transfer to the device using the second profile; means arranged to send to the device a third profile to be installed on the SIM, the third profile being different from the second profile.

In a fourth aspect, the present disclosure provides a computer program comprising computer readable instructions which, when executed by a processor of a computer cause the computer to carry out the method of any one of said first aspect or said second aspect.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the disclosure.

### BRIEF DESCRIPTION OF THE DRAWINGS

Embodiments of the invention will be described, by way of example, with reference to the following drawings, in which:

FIG. 1 is an explanatory diagram of a system for data transmission according to an embodiment;

FIG. 2 is an explanatory diagram of a method useable by the system of FIG. 1 in a first embodiment; and

FIG. 3 is an explanatory diagram of the operation of the system of FIG. 1 in a second embodiment.

Common reference numerals are used throughout the figures to indicate similar features.

### DETAILED DESCRIPTION

Embodiments are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

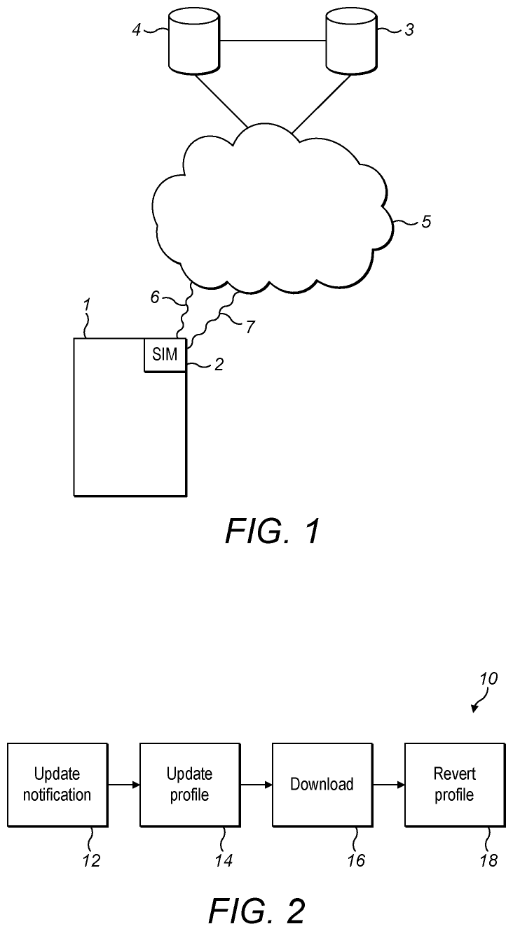

FIG. 1 shows a diagrammatic illustration a system comprising a wireless connected device 1. The wireless connected device 1 may, for example, be arranged to provide Internet of Things (loT) functionality or machine to machine (M2M) functionality. Accordingly, the wireless connected device may be referred to as an IoT device or an M2M device. In order to provide this functionality, the wireless connected device 1 has a Subscriber Identity Module ‘SIM’ 2 to provide wireless connectivity. The wireless connected device 1 may comprise one or more sensors, but in principle can be any type of device or object.

In the illustrated example the SIM 2 is an Embedded Universal Integrated Circuit Card (eUICC) enabled SIM 2, commonly referred to as an eSIM. However, this is not essential. Further, in the illustrated example the SIM 2 is a physical SIM card 2. However, this is also not essential.

The wireless connected device 1 is operated and controlled by an end user, such as an end user organization, having a device server 3. The wireless connected device 1 interacts with the device server 3, generally by sending data to the device server 3 and receiving instructions and updates from the device server 3. Data sent to the device server 3 by the wireless connected device 1 may then be stored and/or processed as necessary.

The wireless connected device 1 is provided with wireless connectivity by a wireless communications link 6 supported by a wireless communication network 5 operated by a mobile network operator (MNO) in communication with the SIM card 2 of the wireless connected device 1.

A communication management service (CMS) 4 manages the provision of wireless connectivity services to the wireless connected device 1 on behalf of the end user. A communication management service (CMS) 4 may alternatively be referred to as a communication management platform (CMP).

In order to equip wireless connected devices, such as wireless connected device 1, with the necessary wireless connectivity desired by end users, for example to provide desired M2M or IoT functionality, it is necessary to provision subscriber SIM cards of the wireless connected devices to allow them to access the different wireless networks operated by various Mobile Network Operators (MNOs). Wireless connectivity is used to refer to both the wireless services which are available and the geographical area in which they are available. In practice, each wireless network generally has a limited geographical coverage, and different MNOs may offer and support different services through their respective wireless networks, so that it is commonly necessary for a single wireless connected device to be able to access multiple different wireless networks operated by different Mobile Network Operators (MNOs) in order to provide the wireless connectivity desired by end users. End users in the M2M or IoT industries generally use the services of Connectivity Management Services (CMS) or Connectivity Management Platforms (CMP) to manage their relationships with the MNOs on their behalf, in order to reduce complexity and expedite time to market for the end users, who will typically be deploying large numbers of SIM cards on large numbers of wireless connected devices.

In FIG. 1, only a single mobile communications network 5 operated by a Mobile Network Operator (MNO) is shown, for clarity. It will be understood that in practice there are a large number of different mobile communications networks that are available for the end user to select, that are operated by individual MNOs or groups or alliances of MNOs. These different mobile communications networks may have different geographical extents which may be separate, or may partially or completely overlap one another.

When the end user wishes to update the wireless connected device 1 the update is made available to the wireless connected device through the device server 3. The update may, for example, be an update of software or firmware on the wireless connected device 1.

It will be understood that in practice, in order for the wireless connected device 1 to provide the M2M or IoT functionality desired by end users it will usually be necessary to enable the wireless connected device 1 to communicate with multiple different wireless networks. This may, for example, be necessary as a result of movement of the wireless connected devices, which may result in the wireless connected device 1 moving out of the area of coverage of a wireless network currently providing the wireless connected device with wireless connectivity, and having to change to another wireless network. However, by design, under the GSM Association (GSMA) standard, MNO subscribers and their physical SIM card pairings are only available to be provisioned on their own home network and registered to a single core network. This limitation has been seen as a commercial obstacle in some telecommunications industries, and as a result a number of technical or commercial solutions to allow use of a SIM card on other networks than the SIM card MNO home network have been developed.

As one technical solution in order to enable a SIM card to be connected to any wireless network, and to enable a standardized model for global wireless connectivity, the Embedded Universal Integrated Circuit Card (eUICC) has been created and agreed as a model supported by MNOs. The eUICC technology allows remote provisioning over the air (OTA) of an eUICC enabled physical SIM card (eSIM) with a new profile to enable the SIM card to access a network of an MNO even when the SIM card does not belong to that MNO. This allows the provider of wireless connectivity to a SIM card to be changed after the physical SIM card has been procured and/or deployed. The OTA Remote Subscription Provisioning (RSP) is a 3GPP standard and is provided by several providers. Other technical solutions to providing a SIM card supporting remote profile provisioning, enabling remote provisioning over the air of the SIM card with a new profile also exist.

The eUICC OTA provisioning process can be performed as required throughout the lifetime of a physical SIM card, enabling a SIM card to have new connectivity services added that belong to different MNOs for either service availability/coverage or commercial reasons, and to have redundant connectivity services removed.

In broad terms, the present disclosure is based upon the general concept of, for a wireless connected device 1 having a subscriber profile suitable for handling the communication and data transfer tasks expected to be required in normal or typical operation of the wireless connected device 1, and having a SIM card 2 supporting remote provisioning of subscriber profiles, providing software or firmware updates, or other exceptional data transfers, to or from the wireless connected device 1 by first installing a new update profile onto the SIM card 2, the update profile supporting wireless connectivity matched to the requirements of the update or other exceptional data transfer, and then using the new profile to download the update or other exceptional data transfer to the wireless connected device 1. Once the update or other exceptional data transfer has been provided to the wireless connected device 1 the original profile is reinstalled in place of the update profile for ongoing normal use. In the illustrated example the SIM card 2 is an eUICC enabled SIM card 2.

Thus, the present disclosure allows the connectivity services required for normal operation to be distinguished from, and provided for separately from, the connectivity services required for exceptional events, for example support and maintenance actions, such as upgrades, or other exceptional data transfers.

A method of providing an update to a wireless connected device 1 according to a first embodiment will now be described with reference to FIGS. 1 and 2.

FIG. 2 shows a flow diagram of a computer-implemented method 10 of automatically providing an update to a wireless connected device 1 according to the first embodiment. The update may, for example, be a software or firmware update required in order to optimize the operation of the wireless connected device 1, to comply with new regulatory requirements, or to ensure proper integration of the wireless connected device 1 with other parts of a data processing and storage system to which the wireless connected device 1 reports data, or for other reasons.

As discussed above, in the illustrated embodiment the wireless connected device 1 has an eUICC enabled SIM card 2. The eUICC enabled SIM card 2 of the wireless connected device 1 has an operating profile installed, and uses this operating profile to provide the wireless communication link 6 to the wireless communications network 5 which is used in normal operation of the wireless connected device 1. The operating profile of the eUICC enabled SIM card 2 of the wireless connected device 1 has characteristics such as charge rates, supported data transfer rates, QoS, and the like, selected or arranged to support or match the requirements of the wireless connected device 1 in normal operation.

In a first “Update Notification” block 12 the device server 3 notifies the Connectivity Management Service (CMS) 4 that the wireless connected device 1 is to be updated with an update from the device server 3. The update may, for example, be a software or firmware update for the wireless connected device 1. Once the CMS 4 receives the update notification the updating method proceeds automatically.

Then, in an “Update Profile” block 14 the CMS 4 instructs the wireless connected device 1 to obtain the update from the device server 3, and downloads and installs a new, update profile onto the eUICC enabled SIM card 2 of the wireless connected device 1 through the wireless communication link 6 between the wireless connected device 1 and the wireless communication network 5. The update profile has characteristics such as charge rates, supported data transfer rates, QoS, and the like, selected or arranged to support or match the requirements of the wireless connected device 1 to carry out the update.

After the update profile has been installed onto the eUICC enabled SIM card 2 of the wireless connected device 1, the wireless connected device 1 uses the update profile on the SIM card 2 to establish a new wireless communication link 7 between the wireless connected device 1 and the wireless communication network 5 to the device server 3. Then, in a “Download” block 16, the wireless connected device 1 uses the update profile on the SIM card 2 to download the update from the device server through the wireless communication link 7.

Then, when the download of the update has been completed, in a “Revert Profile” block 18, the CMS 4 reinstalls the original operating profile. The wireless connected device 1 can then install, or otherwise action, the update, and use the operating profile to re-establish a wireless communication link 6 to the wireless communications network 5.

The update can be applied by the wireless connected device 1 once it has been downloaded. The reinstalling of the original operating profile may be carried out immediately the download is completed, or only after the update has been applied, as appropriate in any specific implementation.

In the first embodiment described above the SIM card 2 is an eUICC enabled SIM card 2, so that the eUICC technology and protocols are used to carry out the installing and re-installing of the different operating profiles. In examples where different approaches to a SIM card supporting remote provisioning of a subscriber profile are used, other technologies and protocols may be used to carry out the installing and re-installing of the different operating profiles.

In the first embodiment described above the new wireless communication link 7 using the installer profile is with the same wireless communication network 5 as the wireless communication link 6 using the operating profile. This is not essential. In some examples the new wireless communication link 7 using the update profile may be with a different wireless communication network from the wireless communication link 6 using the operating profile. This may be desirable, for example, if the wireless communication network 5 does not offer a suitable connectivity service which is suitable for downloading the update. The connectivity services offered by the wireless communication network 5 may, for example, be unsuitable for downloading the update because of quality of service (QoS) and/or cost reasons. In some examples the operating profile and the installer profile may be linked with different MNOs.

In the first embodiment described above, in some examples the CMS 4 may reinstall the original operating profile on the wireless connected device 1 after the update has been downloaded by downloading the original operating profile to the wireless connected device 1. In other examples, the wireless connected device 1 may retain a copy of the original operating profile when the update profile is installed, so that the CMS 4 can simply instruct the wireless connected device 1 to reinstate the original operating profile using this copy without any downloading. In some examples the wireless connected device 1 may reinstate the original operating profile itself after the update has been downloaded, without requiring any specific instructions from the CMS 4.

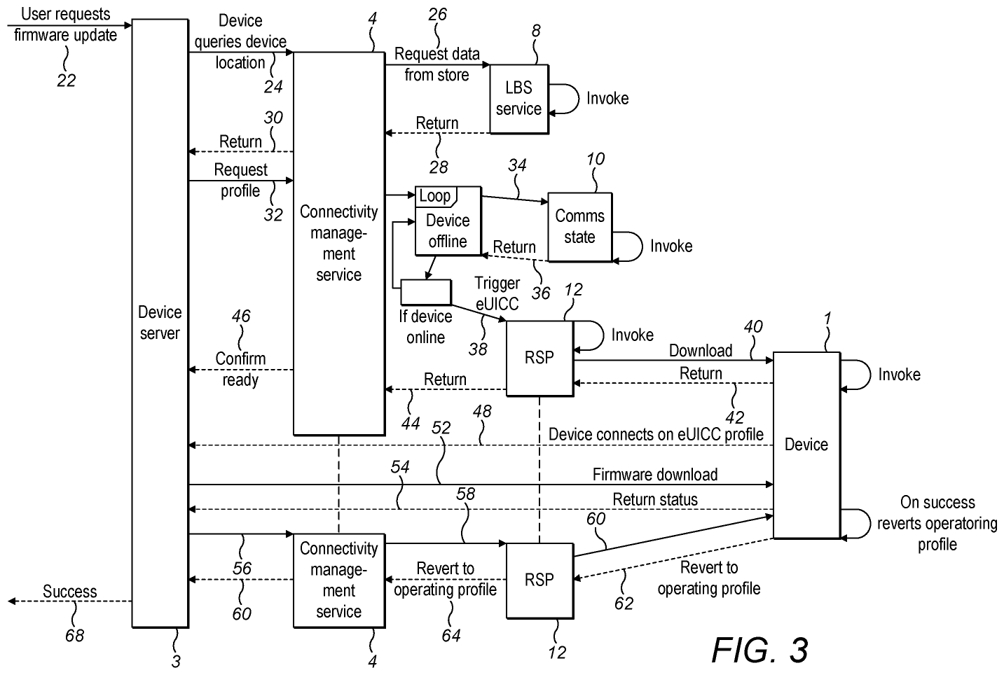

A computer-implemented method of automatically providing an update to a wireless connected device 1 according to a second embodiment will now be described with reference to FIGS. 1 and 3.

FIG. 3 shows a schematic diagram of a method 20 of automatically providing an update to a wireless connected device 1 according to the second embodiment. Similarly to the first embodiment, the update may be required, for example, in order to optimize the operation of the wireless connected device 1, to comply with new regulatory requirements, or to ensure proper integration of the wireless connected device 1 with other parts of a data processing and storage system to which the wireless connected device 1 reports data, or for other reasons.

In the second embodiment illustrated in FIG. 3 the update is a firmware update of firmware on the wireless connected device 1. In the illustrated second embodiment the wireless connected device 1 has an eUICC enabled SIM card 2 with an operating profile installed. Similarly to the first embodiment, the operating profile has characteristics such as charge rates, supported data transfer rates, QoS, and the like, selected or arranged to support or match the requirements of the wireless connected device 1 in normal operation.

The method 20 is started by an end user (not shown) sending a firmware update request 22 for the wireless connected device 1 to the device server 3. Once the device server 3 receives the firmware update request 22 the rest of the method 20 then proceeds automatically.

In response to the firmware update request 22, the device server 3 sends a location query 24 requesting information about the location of the wireless connected device 1 to the Connectivity Management Service (CMS) 4.

The CMS 4 then sends a request 26 for location data for the wireless connected device 1 to a Location Based Service (LBS) 8. The requested location data 28 for the wireless connected device 1 is provided in return by the LBS 8.

The location data may, for example, be obtained from the MNO of the mobile communications network 5 by the LBS 8 and provided to the CMS 4.

The CMS 4 then returns a location data message 30 containing the location data 28 for the wireless connected device 1 to the device server 3.

The device server 3 then selects, based on the indicated location of the wireless connected device 1, a profile to be used as an updater profile to deliver the firmware update to the wireless connected device 1 from a plurality of possible profiles. As is discussed above, different wireless networks have different geographic coverage and offer different wireless connectivity services. Further, there may be legal and/or regulatory issues in some jurisdictions. As a result, the most appropriate profile to carry out the firmware update may vary with parameters of the update, such as the size of the update, the data transfer rate required by the update, the QoS required by the update, and/or the location of the wireless connected device 1.

Accordingly, the selection of the profile from the plurality of possible profiles may, for example, be based on any one of, or any combination of more than one of; the size of the intended update, the data transfer rate required by the update, the QoS required by the update, the location of the wireless connected device 1; the identities of wireless networks available to the wireless connected device 1 at the location; regulatory requirements at the location. Accordingly, the selected profile has characteristics such as charge rates, supported data transfer rates, QoS, and the like, selected or arranged to support or match the requirements of the wireless connected device 1 to carry out the update.

In some examples, the device server 3 may not proceed with the firmware update if the indicated location of the wireless connected device 1 is a location where the firmware update is impractical, for example, if the indicated location is one where the available Quality of Service (QoS) is too poor for the update to be reliably completed. In such examples the device server 3 may carry out the firmware update at a later time when the wireless connected device 1 is at a different location.

After the device server 3 has made the profile selection, the device server 3 sends an updater profile request 32 to the CMS 4 requesting that the selected profile should be installed to be used as an updater profile to carry out the firmware update.

In response to the updater profile request 32, the CMS 4 sends a request 34 to determine the communications status of the wireless connected device 1 to a communications status service 10. The communications status service 10 provides in return communications status information 36 that is determined from the integration of Access Point Name Infrastructure into the CMS 4 indicating whether the wireless connected device 1 is online or offline.

If the communications status information 36 indicates that the wireless connected device 1 is offline the CMS 4 waits for a predetermined time, and then sends a further request 34 to the communications status service 10. Alternatively, if the communications status information 36 indicates that the wireless connected device 1 is online, the CMS 4 sends an instruction 38 to a Remote Subscription Provisioner (RSP) 12 to install the selected updater profile to the eUICC enabled SIM card 2 of the wireless connected device 1.

The RSP 12 then downloads the selected updater profile 40 to the eUICC enabled SIM card 2 of the wireless connected device 1. This may, for example, be carried out by the MNO of the wireless communications network 5 using the eUICC OTA provisioning process. The MNO can carry out the eUICC OTA provisioning process via a Subscription Manager Secure Routing (SM-SR) of the MNO using an adaptor of the SM-SR/Subscription Manager Data Preparation (SM-DP) provider. As is explained above, techniques for downloading and installing profiles to an eUICC enabled SIM card are known, and need not be described in detail herein.

The wireless connected device 1 then installs and activates the selected updater profile on the eUICC enabled SIM card 2 of the wireless connected device 1, replacing the operating profile. When this has been completed the wireless connected device 1 sends a confirmation message 42 to the RSP 12.

Then, in response to receiving the confirmation message 42, the RSP 12 sends a confirmation message 44 to the CMS 4 confirming that the selected updater profile is active on the wireless connected device 1.

Then, in response to receiving the confirmation message 44, the CMS 4 in turn sends a confirmation message 46 to the device server 3 confirming that the selected updater profile 40 is active on the wireless connected device 1.

After the selected updater profile has been installed and activated on the eUICC enabled SIM card 2 of the wireless connected device 1, the wireless connected device 1 connects 48 to the device server 3 using the selected updater profile. This connection may be performed by a communication agent on the SIM card 2. Such communication agents are generally installed on manufacture of SIM cards supporting remote profile provisioning, in order to support the remote provisioning process. In some examples the wireless connected device 1 may do this automatically in response to detecting the presence of an active updater profile on the eUICC enabled SIM card 2 of the wireless connected device 1.

Similarly to the first embodiment described above, this connection to by the wireless connected device 1 using the selected updater profile may be through the same communications network or a different communications network to the communications network(s) used by the wireless connected device 1 when using the operating profile.

The device server 3 then downloads the firmware update 52 to the wireless connected device 1 using the selected updater profile.

When the firmware update 52 has been completed, the wireless connected device 1 sends a confirmation 54 of completion of the download to the device server 3.

In response to receiving the confirmation 54, the device server 3 sends an profile revert request 56 to the CMS 4 requesting that the eUICC enabled SIM card 2 of the wireless connected device 1 should revert to the original operating profile.

Then, in response to receiving the profile revert request 56, the CMS 4 sends a profile revert request 58 to the RSP 12 requesting that the eUICC enabled SIM card 2 of the wireless connected device 1 should revert to the original operating profile.

Then, in response to receiving the profile revert request 58, the RSP 12 downloads the original operating profile 60 to the eUICC enabled SIM card 2 of the wireless connected device 1. This may, for example, be carried out by the MNO of the wireless communications network 5 using the eUICC OTA provisioning process. The MNO can carry out the eUICC OTA provisioning process via a Subscription Manager Secure Routing (SM-SR) of the MNO using an adaptor of the SM-SR/Subscription Manager Data Preparation (SM-DP) provider. As is explained above, techniques for downloading and installing profiles to an eUICC enabled SIM card are known, and need not be described in detail herein.

The wireless connected device 1 then installs and activates the operating profile on the eUICC enabled SIM card 2 of the wireless connected device 1, replacing the updater profile. When this has been completed the wireless connected device 1 sends a confirmation message 62 to the RSP 12.

Then, in response to receiving the confirmation message 62, the RSP 12 sends a confirmation message 64 to the CMS 4 confirming that the operating profile is active on the wireless connected device 1.

Then, in response to receiving the confirmation message 64, the CMS 4 in turn sends a confirmation message 66 to the device server 3 confirming that the selected updater profile 40 is active on the wireless connected device 1.

Then, the device server 3 sends a message 68 confirming that the firmware update has been completed to the end user, ending the update method 20.

Similarly to the first embodiment, In the second embodiment described above the SIM card 2 is an eUICC enabled SIM card 2, so that the eUICC technology and protocols are used to carry out the installing and re-installing of the different operating profiles. This is not essential, and in other examples different approaches to a SIM card supporting remotely provisioning of a subscriber profile may be used. In examples where different approaches are used, other appropriate technologies and protocols may be used to carry out the installing and re-installing of the different operating profiles, instead of the eUICC technology and protocols.

In the second embodiment described above, the wireless connected device 1 connects to the device server 3 to initiate the download of the firmware update. In other examples the downloading process may instead be initiated by the device server 3. In some examples the device server 3 may send a manifest of the firmware update to the wireless connected device 1 using the updater profile. The connected device 1 can the download a body of the firmware update from the device server using the updater profile based on the information in the manifest. The manifest may, for example specify what is to be done with the firmware update by the wireless connected device 1. For example, the manifest may identify the space required by the body of the update.

In the second embodiment described above, the LBS 8, the communications status service 10 and the RSP 12 are separate from the CMS 4. In some examples the LBS 8 may be a part of the CMS 4. In some examples, one, some, or all of the LBS 8, the communications status service 10 and the RSP 12 may be a part of the CMS 4.

In the second embodiment described above the Location Based Service (LBS) 8 obtains location data in response to a request from the CMS 4, which request is in turn made in response to a location query 24 from the device server 3. In some alternative examples the LBS 8 may operate asynchronously. That is, the location data may be obtained by the LBS 8 independently of the location query 24 from the device server 3 and stored in the LBS 8, or in the CMS 4. This stored location data may then be sent to the device server 3 in response to the location query 24 from the device server 3.

In the second embodiment described above the location of the wireless connected device 1 is determined before the update is carried out, and the decision to proceed with the update and the selection of the updater profile to be used are based upon the determined location. This is not essential. In some examples a common updater profile may be used for all updates, or a specific updater profile may be assigned to be used for a particular update, without taking location into account. In some examples it may be attempted to carry out the update regardless of the location. In some such examples the location of the wireless connected device 1 I may not be determined. In such examples the LBS 8 may be omitted.

In the second embodiment described above a number of functions are carried out by the device server 3 and the CMS 4. In other examples these functions could be carried out by different ones of the device server 3 and the CMS 4. In particular, the decision whether or not to change the profile being used by the wireless connected device 1 may be made by the CMS 4 based on the expected data transfer requirements of the wireless connected device 1 in order to carry out activities instructed by the device server 3.

In the second embodiment described above the reversion to the original profile, comprising the downloading and installing of the operating profile is carried out in response to completion of the download of the firmware update. In other examples either or both of the downloading and installing of a profile may be triggered directly or indirectly by the completion of a data transfer.

In the embodiments described above the wireless connected device 1 is updated with an update from the device server 3. In other examples the exceptional or unusual event triggering the automatic method to download and install a new profile onto the eUICC enabled SIM card 2 of the wireless connected device 1 may be something other than an update. For example, the CMS 4, or some other part of the system, such as the device server 3, or the wireless connected device itself, or some server or other element linked to the illustrated system, may identify that an upcoming exceptional or unusual event is planned to occur in the future and respond by starting the method to download and install a new profile which is better suited to handling the exceptional or unusual event than the normal profile currently installed on the eUICC enabled SIM card 2 of the wireless connected device 1.

In some examples the identification of an upcoming exceptional or unusual event may be based upon a type of an event, for example by comparing a type of an event with a list of events which are to be regarded as exceptional or unusual events, for example a software or firmware update as described above. In such examples the new profile to be downloaded and used to handle the event may be based on the type of event, for example by being specified by the list of events. Alternatively, a new profile to be downloaded and used to handle the event may be separately determined based upon the characteristics of the event, such as one or more of the total size of the data to be transferred, the required data transfer rate, and the required Quality of Service (QoS) for the event. The use of a profile selected based on the total size of the data to be transferred and/or the required data transfer rate may allow excessive charges or costs to be avoided. The use of a profile selected based on a required QoS may allow critical tasks, such as software or firmware updates, or a download or upload of data of high importance, to be successfully carried out with a high probability of success by ensuring that the communication channel used, which is supported by the profile, has a sufficiently high QoS.

In some examples, the identification of an upcoming exceptional or unusual event may be based upon a total size and/or required data transfer rate of an upcoming task, with tasks having a total size and/or required data transfer rate above a predetermined threshold being regarded as exceptional or unusual events. These could, for example, be a software or firmware update as described above, or a large data download or upload task. In such examples the new profile to be downloaded and used to handle the event may be determined based upon the characteristics of the event, such as one or more of the total size of the data to be transferred and/or the required data transfer rate.

In some examples, the identification of an upcoming exceptional or unusual event may be based upon a degree of importance assigned to an upcoming task, with tasks having a high importance being regarded as exceptional or unusual events. These could, for example, be a critical software or firmware update as described above, or an important data download or upload task. In such examples the new profile to be downloaded and used to handle the event may be determined based upon the characteristics of the event, such as a required QoS associated with the event.

In other examples the system may record and analyse the operation of the wireless connected device over time to determine what events or parameters of events result in operation of the wireless connected device 1 which is not suited to the normal profile. For example, events which cause the wireless device 1 to exceed the limits of the normal profile and incur excessive costs, or events which cannot be reliably completed due to QoS issues. Such determined events and/or parameters can then be used to identify upcoming exceptional or unusual events and trigger the automatic method to download and install a new profile onto the eUICC enabled SIM card 2 of the wireless connected device 1. In some examples this determination may be carried out using machine learning.

It should be understood that the second embodiment described above is a more specific, and more detailed, example of the first embodiment. Accordingly, features described with respect to one embodiment may be added to or combined with features of the other embodiment.

The embodiments described above are described as being automatically carried out without further human intervention once a decision to update a wireless connected device has been made. In other examples some human decision making may be involved.

The second embodiment described above relates to a method of downloading a firmware update. This is by way of example only, and other types of software update could be carried out by the described method.

In the embodiments described above an operating profile is replaced by an updater profile, and subsequently the updater profile is replaced by the original operating profile. In some alternative examples where it was desired, for some reason, to change the operating profile, the updater profile could be replaced by a new operating profile instead of the original operating profile.

As can be understood from the above description, the present disclosure allows firmware and software upgrades to be send to devices using a connectivity profile that is suitable for the nature and requirements of the update, without any requirement for compromise operating requirements are other times into account. Further, combining the automated service provisioning with the user requested firmware allows the highest level of quality to be provided for devices with different usage patterns, and allows an appropriate connectivity profile to be used for different usage patterns, for example a profile using Long-Term Evolution (LTE) may be used for large downloads, such as firmware downloads, and may enable the cost of providing support and updates to devices in the field to be reduced.

As is discussed above, the present disclosure allows the connectivity services required for normal operation to be distinguished from, and provided for separately from, the connectivity services required for support and maintenance actions, such as upgrades. These required connectivity services may for example relate to quality of service (QoS) requirements, or volume of data to be transferred. In some examples a device in service may need access to multiple different wireless networks to provide reliability of connection for small data volumes, but use a single LTE network for updates to take advantage of lower costs for large data amounts.

The present disclosure also allows the network cost (i.e., the costs charged by the network operators of the different wireless networks) of carrying out an update to be removed from a primary subscription linked to the operating profile and assigned to a temporary, or dedicated subscription linked to the update profile. This may provide benefits in enabling more accurate behavior reporting and usage trend analysis by ensuring that this can be based only on normal operation, and not on update activity. Further, this may also allow, if required, for split billing of updates separately from normal operation, which may be desirable, for example where a device manufacturer pays for any necessary support or firmware updates to devices, while the end user pays for the devices normal operating costs for their primary use case. Further, the present disclosure may enable better cost control for updates.

Further, the system does not rely on an SMS to carry out the update, and only proceeds with the update when the wireless connected device is online. Accordingly, the system will be aware whether or not the update is carried out.

The embodiments described above relate to the downloading of updates to a device. In other examples the disclosed approach may be applied to other situations where there are changes in the amount of data to be transferred. For example, an ATM machine only needs to transfer relatively small amounts of data to a bank transaction computer system in normal operation in order to authorize and report transactions. However, following a security event, such as an apparent attempt to obtain funds illicitly, the ATM machine may need to upload a relatively large amount of data, such as image and/or videos of the persons involved, to a bank security system. In this case a normal operating profile could be replaced by a reporting profile better suited to the uploading of large amounts of data.

In some examples, instead of installing a new profile only when an update is to be carried out the, the system may be able to select from a range of different profiles intended for use with different levels of data transfer, possibly with different networks and/or operators. The selection of new profiles and the triggering of changes to the profile used by the wireless connected device 1 may be carried out in response to actual changes in data usage, that is, the amount of data to be transferred, but it will generally be preferred to predict the amount of data usage and make corresponding changes to the profile to be used by the wireless connected device 1 in advance of any data usage changes.

The above description discusses embodiments of the invention with reference to a single user, a single wireless connected device, and a single wireless communication network for clarity. It will be understood that in practice the system may be shared by a plurality of users, with a large number, and possibly by a very large number, of wireless connected devices simultaneously, over a plurality of communication networks.

The above description discusses embodiments of the invention with reference to providing updates to SIM cards of a wireless connected device having IoT and/or M2M connectivity. In other examples the present disclosure may be used to provide updates to SIM cards of devices with wireless communications connectivity for other applications.

The embodiment described above are fully automatic. In some alternative examples a user or operator of the system may instruct some steps of the method to be carried out.

In the described embodiments of the invention the system may be implemented as any form of a computing and/or electronic device.

Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

Although the CMS is shown as a single device it will be appreciated that the CMS may be distributed or located remotely and accessed via a network or other communication link (e.g. using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this disclosure.

1. A computer-implemented method of carrying out a data transfer comprising:
providing a device having a Subscriber Identity Module ‘SIM’ supporting remote profile provisioning, and having a first profile;
providing a second profile, different from the first profile;
installing the second profile on the SIM;
using the second profile to carry out a data transfer;
providing a third profile, different from the second profile; and
installing the third profile on the SIM.

2. The method of claim 1, in which the third profile is the same as the first profile.

3. The method of claim 1, in which the second profile is installed in place of the first profile and the third profile is installed in place of the second profile.

4. The method of claim 1, in which the data transfer has a predicted size, and further comprising selecting a second profile to be provided from a plurality of possible profiles based upon the predicted size of the data transfer.

5. The method of claim 1, and further comprising:
determining a location of the device; and
selecting a second profile to be provided from a plurality of possible profiles based upon the determined location of the device.

6. The method of claim 1, in which providing the second profile comprises downloading the second profile to the device using the first profile.

7. The method of claim 1, in which the providing and installing of the second profile are carried out in response to an identification of a future event comprising the data transfer.

8. The method of claim 7, in which the first profile has characteristics arranged to support normal operation of the device.

9. The method of claim 8, in which the future event is an exceptional event different from normal operation of the device; or in which the second profile has characteristics arranged to support operation of the device during the future event.

10. (canceled)

11. The method of claim 7, in which the identification of the future event is based upon at least one of: a type of the future event; a required data transfer size of the future event; a required data transfer rate of the future event; a required Quality of Service of the future event; an importance of the future event.

12. The method of claim 7, and further comprising selecting a second profile to be provided from a plurality of possible profiles based upon at least one of: a type of the future event; a data transfer size of the future event; a required data transfer rate of the future event; a required Quality of Service of the future event; an importance of the future event.

13. The method of claim 1, in which the data transfer is a data transfer to the device; or
the data transfer is a data transfer from the device; or
in which providing the second profile comprises downloading the second profile to the device; and further comprising:
determining that the device is online before downloading the second profile; or
in which providing the third profile comprises downloading the third profile to the device using the second profile; or
in which installing the third profile is carried out in response to completion of the data transfer; or
in which the SIM is an Embedded Universal Integrated Circuit Card ‘eUICC’ enabled SIM.

14. (canceled)

15. (canceled)

16. (canceled)

17. (canceled)

18. The method of claim 1, in which the data transfer is a transfer of data to the device; and
preferably, in which the data transfer is a transfer of a software or firmware update to the device; and
preferably, further comprising applying the update to the device.

19. (canceled)

20. (canceled)

21. The method of claim 1, further comprising receiving an instruction to carry out the data transfer, and in response to receiving the instruction carrying out providing the second profile, installing the second profile, using the second profile, providing the third profile and installing the third profile.

22. The method of claim 1, in which the device is a wireless connected device.

23. (canceled)

24. A computer-implemented method of carrying out a data transfer comprising:
sending, to a device having a Subscriber Identity Module ‘SIM’ supporting remote profile provisioning, and having a first profile, a second profile to be installed on the SIM, the second profile being different from the first profile;
carrying out a data transfer with the device using the second profile;
sending to the device a third profile to be installed on the SIM, the third profile being different from the second profile.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. The method of claim 24, and further comprising:
determining that the device is online before sending the second profile.

37. (canceled)

38. The method of claim 24, in which the sending the third profile is carried out in response to completion of the data transfer.

39. The method of claim 24, in which the installing the third profile is carried out in response to completion of the data transfer.

40. (canceled)

41. (canceled)

42. A data transfer system comprising:
means arranged to send, to a device having a Subscriber Identity Module ‘SIM’ supporting remote profile provisioning, and having a first profile, a second profile to be installed on the SIM, the second profile being different from the first profile;
means arranged to carry out a data transfer to the device using the second profile;
means arranged to send to the device a third profile to be installed on the SIM, the third profile being different from the second profile.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)
